(19) United States
(12) Patent Application Publication
(10) Pub. No.: US 2023/0039374 A1
(43) Pub. Date: Feb. 9, 2023

(54) CONNECTING LINK AND CHAIN

(71) Applicant: TSUBAKIMOTO CHAIN CO., Osaka (JP)

(72) Inventors: Yuji Abe, Osaka-shi (JP); Kenichi Kamioka, Osaka-shi (JP)

(73) Assignee: TSUBAKIMOTO CHAIN CO., Osaka (JP)

(21) Appl. No.: 17/879,163

(22) Filed: Aug. 2, 2022

(30) Foreign Application Priority Data
Aug. 5, 2021 (JP) 2021-129137

(51) Int. Cl. F16G 15/02

(52) U.S. Cl. CPC F16G 15/02

(57) ABSTRACT

A connecting link includes a connecting pin, a first link plate, a second link plate, and a nut member. The connecting pin includes an external thread portion and a frustum-shaped portion. The first link plate includes a hole at each of one end and an other end in a longitudinal direction. At least one of the hole at the one end and the hole at the other end of the first link plate functions as a first pin hole. The second link plate includes a hole at each of one end and an other end in a longitudinal direction. At least one of the hole at the one end and the hole at the other end of the second link plate functions as a second pin hole. The nut member is capable of being threaded to the external thread portion of the connecting pin.

### BACKGROUND

### 1. Field

The present disclosure relates to a connecting link used to connect a cut chain and to a chain that has been connected using the connecting link.

### 2. Description of Related Art

For example, Japanese Laid-Open Patent Publication No. 2011-94660 discloses a transmission chain. The transmission chain includes inner link plates and outer link plates that alternate in a longitudinal direction of the chain. The inner link plates and the outer link plates are arranged in series such that ends of the inner link plates and ends of the outer link plates overlap with each other in a width direction of the chain. The ends of inner link plates and outer link plates that are adjacent to each other in the longitudinal direction of the chain are pivotally connected to each other with a coupling pin. Ends of the coupling pin are press-fitted into pin holes of the outer link plates. That is, the coupling pin is in a state of interference fit, in which the coupling pin is fitted into the pin holes to be non-rotatable.

In some cases, a transmission chain is cut and connected in order to adjust the chain to a desired length at the site of use by a user. In such a case, if the coupling pin is in a state of clearance fit with the pin holes of the outer link plates, in which the coupling pin is fitted into the pin holes so as to be rotatable with respect to the pin holes, the user can readily fit the ends of the coupling pin into the pin holes. However, the state of clearance fit causes the inner circumferential surfaces of the pin holes and the outer circumferential surfaces of the coupling pin to slide against each other. Thus, wear caused by a prolonged use can increase the diameter of the pin holes, so that the chain that has been cut and connected may be stretched undesirably.

In contrast, if the coupling pin is in a state of interference fit with the pin holes of the outer link plates, in which the coupling pin is fitted into the pin holes to be non-rotatable with respect to the pin holes, the inner circumferential surfaces of the pin holes and the outer circumferential surfaces of the coupling pin will not slide against each other. This restricts the chain that has been cut and connected from being stretched undesirably. However, in order to achieve a state of interference fit of the ends of coupling pin with the pin holes of the outer link plates, the coupling pin must be press-fitted into the pin holes using a hydraulic machine or must be pounded into the pin holes with a large hammer. Thus, although the interference fit restricts the chain that has been cut and connected from being stretched undesirably, it takes significant time and effort to fit the coupling pins into the pin holes when connecting the cut chain.

### SUMMARY

In a general aspect, a connecting link used to connect a cut chain is provided. The chain includes links arranged in series in a longitudinal direction of the chain. The links adjacent to each other in the longitudinal direction are pivotally coupled to each other. The connecting link includes a connecting pin, a first link plate, a second link plate, and a nut member. The connecting pin includes an external thread portion at a distal end and a frustum-shaped portion between the external thread portion and a proximal end. The frustum-shaped portion is formed to have a cross-sectional area increasing toward the proximal end. The first link plate includes a hole capable of receiving the connecting pin at each of one end and an other end in a longitudinal direction. At least one of the hole at the one end and the hole at the other end functions as a first pin hole into which a proximal end of the connecting pin is fitted so as to be non-rotatable. The second link plate includes a hole capable of receiving the connecting pin at each of one end and an other end in a longitudinal direction. At least one of the hole at the one end and the hole at the other end function as a second pin hole. The external thread portion of the connecting pin is passable through the second pin hole. The second pin hole includes an inner surface. The inner surface has a shape of a conical or pyramidal recess that corresponds to an outer surface of the frustum-shaped portion. The nut member is capable of being threaded to the external thread portion of the connecting pin.

In another general aspect, a chain is provided that includes links arranged in series in a longitudinal direction of the chain, a coupling pin that pivotally couples the links adjacent to each other in the longitudinal direction to each other, and the above-described connecting link. The connecting link is located in an intermediate portion in the longitudinal direction of the chain. The connecting link couples the link adjacent to the connecting link on one side in the longitudinal direction to the link adjacent to the connecting link on an other side.

Other features and aspects will be apparent from the following detailed description, the drawings, and the claims.

### BRIEF DESCRIPTION OF THE DRAWINGS

FIG. 1 is an exploded perspective view showing part of a chain according to one embodiment.

FIG. 2 is a partially cut away plan view showing a portion of the chain that has been cut and connected with a connecting link.

FIG. 3 is an enlarged cross-sectional plan view showing a section in FIG. 2.

FIG. 4 is an exploded perspective view showing part of the connecting link.

FIG. 5 is an exploded perspective view showing part of a connecting link according to a first modification.

FIG. 6 is an exploded perspective view showing part of a connecting link according to a second modification.

FIG. 7 is a cross-sectional plan view showing part of a connecting link according to a third modification.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

A connecting link and a chain according to one embodiment will now be described with reference of the drawings.

<Overall Configuration>

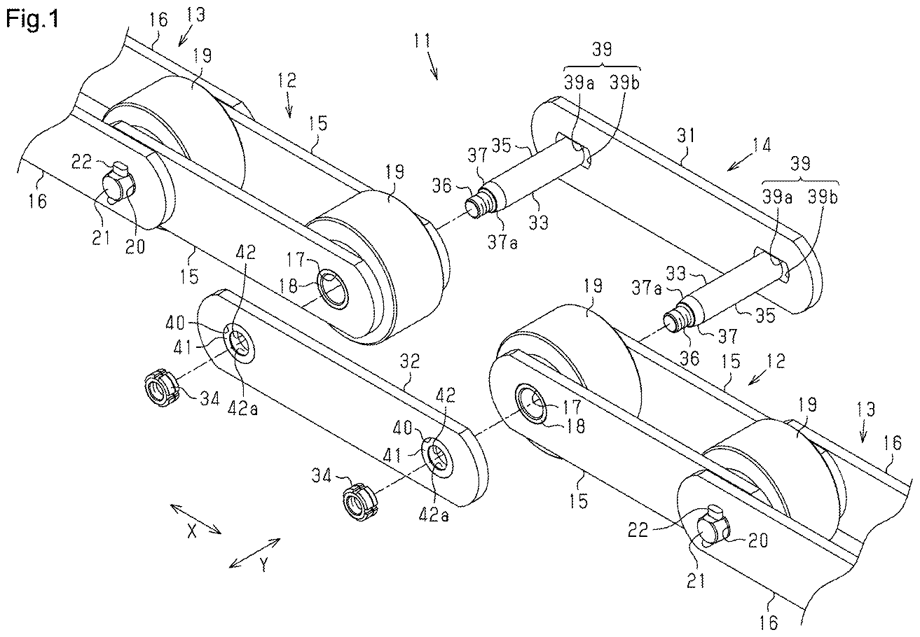

As shown in FIG. 1, a chain 11 according to the present embodiment includes inner links 12, outer links 13 and a connecting link 14, which are arranged in series in a longitudinal direction X of the chain 11. That is, the chain 11 has been cut and connected to adjust its length, for example, at the site of use, for example, by a user. The chain 11 includes the connecting link 14 in an intermediate portion in its longitudinal direction X. With reference to the position of the connecting link 14, an inner link 12 is located on each of one side and an other side in the longitudinal direction X of the chain 11. The connecting link 14 couples the inner link 12 adjacent to the connecting link 14 on one side in the longitudinal direction X of the chain 11 to the inner link 12 adjacent to the connecting link 14 on an other side.

The inner links 12 and the outer links 13 are arranged to alternate in the longitudinal direction X of the chain 11. Each inner link 12 includes two inner link plates 15, which face each other while being spaced apart in a width direction Y. The width direction Y is orthogonal to the longitudinal direction X of the chain 11. Each outer link 13 includes two outer link plates 16, which are arranged to sandwich, from outside with respect to the width direction Y, the two inner link plates 15 of the inner link 12 that is adjacent to the outer link 13 in the longitudinal direction X of the chain 11. The inner link plates 15 and the outer link plates 16 are made of, for example, a steel through, for example, forging or stamping. The inner link plates 15 and the outer link plates 16 are each substantially rectangular and extend in the longitudinal direction X of the chain 11.

Each inner link plate 15 has two circular bushing holes 17 at opposite ends in the longitudinal direction. The bushing holes 17 extend through the inner link plate 15 in the thickness direction. A cylindrical bushing 18 is arranged between the inner link plates 15, which face each other, to maintain the distance between the inner link plates 15 in the width direction Y. Opposite ends of the bushing 18 are respectively fitted into the bushing holes 17 of the inner link plates 15 of a pair to be non-rotatable. A roller 19, which has a diameter larger than that of the bushing 18, is rotatably fitted about the bushing 18. That is, the roller 19 is loosely fitted about the bushing 18 so as to be rotatable.

Each outer link plate 16 includes two circular pin holes 20 at opposite ends in the longitudinal direction. Each pin hole 20 has an inner diameter slightly smaller than that of the bushing 18, and extends through the outer link plate 16 in the thickness direction. Opposite ends of a substantially columnar coupling pin 21 are press-fitted into the pin holes 20 of the outer link plates 16 of a pair. The coupling pin 21 is rotatably inserted into the bushing 18, which is a pin insertion portion of the inner link 12. As shown in FIG. 1, the inner link 12 and the outer link 13 are pivotally coupled to each other using the coupling pin 21, with ends of the inner link plates 15 and the outer link plates 16 that are adjacent to each other in the longitudinal direction X of the chain 11 overlapped with each other. The coupling pin 21 includes a flange-shaped proximal end (not shown in FIG. 1) and a distal end. The proximal end of the coupling pin 21 is engaged with the outer surface of one of the two outer link plates 16. The distal end of the coupling pin 21 protrudes outward from the pin hole 20 of the other outer link plate 16. In this state, the coupling pin 21 is prevented from coming out of the pin hole 20 by attaching a retainer pin 22 to the distal end, which protrudes outward from the pin hole 20 of the outer link plate 16.

<Connecting Link>

As shown in FIGS. 1, 2, and 3, the connecting link 14 includes a first link plate 31, a second link plate 32, connecting pins 33, and nut members 34. The first link plate 31 and the second link plate 32 are each substantially rectangular like the outer link plates 16. The connecting pin 33 has a substantially columnar shape like the coupling pin 21. The first link plate 31 and the second link plate 32 are made of, for example, a steel through, for example, forging or stamping, as in the case of the inner link plates 15 and the outer link plates 16.

<Connecting Pin>

Each connecting pin 33 includes a shaft portion 35, an external thread portion 36, and a frustum-shaped portion 37. The external thread portion 36 is provided at the distal end of the connecting pin 33. The external thread portion 36 has an outer diameter smaller than that of the shaft portion 35. The frustum-shaped portion 37 is closer to the proximal end of the connecting pin 33 than the external thread portion 36, that is, located between the shaft portion 35 and the external thread portion 36. The cross-sectional area of the frustum-shaped portion 37 increases toward the proximal end. The frustum-shaped portion 37 has a shape of a conical frustum so that an outer surface 37a is a surface of a conical frustum. Specifically, the cross-sectional shape of the distal end of the frustum-shaped portion 37 is a circle that is slightly larger than the cross-sectional shape of the external thread portion 36, and the cross-sectional shape of the proximal end of the frustum-shaped portion 37 is a circle having the same size as the cross-sectional shape of the shaft portion 35.

<First Link Plate>

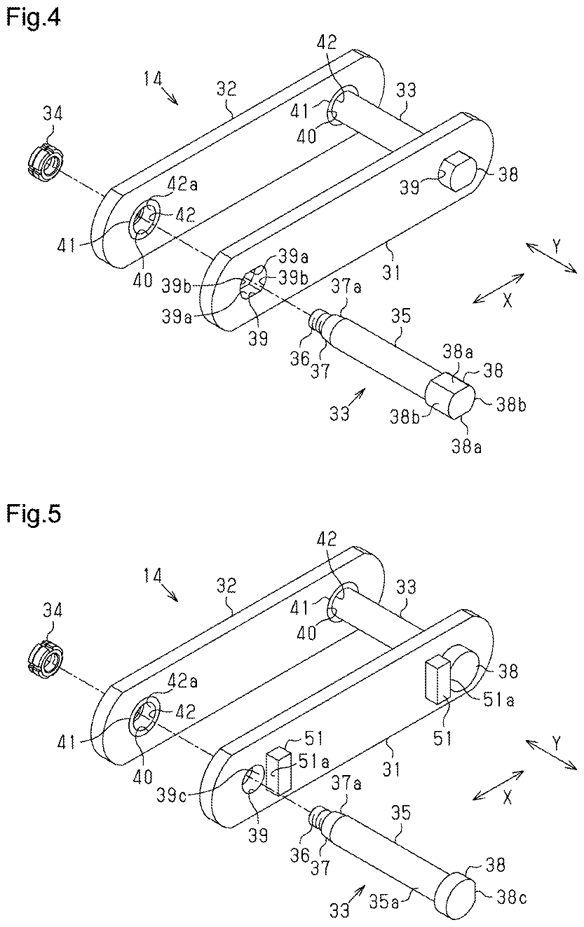

As shown in FIG. 4, the first link plate 31 includes a first pin hole 39 at each of one end and an other end in the longitudinal direction. Each first pin hole 39 is capable of receiving the shaft portion 35 of the connecting pin 33. A proximal end 38 of the connecting pin 33 is fitted into the first pin hole 39 to be non-rotatable. Each first pin hole 39 includes two flat inner surfaces 39a, which extend in the longitudinal direction of the first link plate 31, and two concave inner surfaces 39b, which connect the ends of the flat inner surfaces 39a to each other. An opening width of the first pin hole 39 in a traverse direction of the first link plate 31 corresponds to the distance between the flat inner surfaces 39a, which face each other. This opening width is substantially equal to the outer diameter of the shaft portion 35 of the connecting pin 33. An opening width of the first pin hole 39 in the longitudinal direction of the first link plate 31 corresponds to the longest distance between the concave inner surfaces 39b, which face each other. This opening width is greater than the outer diameter of the shaft portion 35 of the connecting pin 33.

<Rotation Restricting Portion>

The proximal end 38 of the connecting pin 33, which is fitted into the first pin hole 39 to be non-rotatable, has a cross-sectional shape that is the same as the opening shape of the first pin hole 39 as shown in FIG. 4. That is, the proximal end 38 of the connecting pin 33 includes two flat outer surfaces 38a and two convex outer surfaces 38b which connect the ends of the flat outer surfaces 38a to each other. When the proximal end 38 is inserted into the first pin hole 39, the flat outer surfaces 38a are in planar contact with the flat inner surfaces 39a of the first pin hole 39. When the proximal end 38 of the connecting pin 33 is inserted into the first pin hole 39, the convex outer surfaces 38b are in planar contact with the concave inner surfaces 39b of the first pin hole 39. The length of the proximal end 38 in the axial direction of the connecting pin 33 is greater than the thickness of the first link plate 31. In the present embodiment, the flat inner surfaces 39a of the first pin hole 39 of the first link plate 31 contact the flat outer surfaces 38a of the proximal end 38 of the connecting pin 33 so as to function as a rotation restricting portion, which restricts the connecting pin 33 from rotating relative to the first pin hole 39.

As shown in FIG. 1, the connecting pin 33 is supported by the first link plate 31 in a cantilever-like manner, in which the proximal end 38 of the connecting pin 33 is press-fitted into the first pin hole 39 of the first link plate 31. In this case, the connecting pin 33 is integrated with the first link plate 31 in a state of interference fit, in which the proximal end 38 is fitted into the first pin hole 39 to be non-rotatable. In other words, when the chain 11 is cut and connected, the first link plate 31 of the connecting link 14 is handled as a unit that includes the two connecting pins 33 attached in a cantilever-like manner to the first pin holes 39 at one end and the other end in the longitudinal direction.

<Second Link Plate>

As shown in FIGS. 1, 2, and 4, the second link plate 32 includes a fitting hole 40 at each of one end and an other end in the longitudinal direction. Each fitting hole 40 is circular and has a diameter larger than that of the shaft portion 35 of the connecting pin 33. A cylindrical connecting bushing 41 is fitted to and fixed in each fitting hole 40. The connecting bushing 41 has a length in the axial direction that is slightly greater than the thickness of the second link plate 32. The length in the axial direction of the connecting bushing 41 may be the same as or less than the thickness of the second link plate 32. The connecting bushing 41 is made, for example, of a stainless steel having a hardness higher than that of the steel of which the second link plate 32 is made. That is, the connecting bushing 41, which is a component separate from the second link plate 32, is made of a material different from that of the second link plate 32. In other words, the materials of the connecting bushing 41 and the second link plate 32, which at least form the surfaces, are different from each other in the hardness, which is one example of the properties of the materials. A second pin hole 42 extends in the axial direction through the connecting bushing 41. The external thread portion 36 of the connecting pin 33 is passable through the second pin hole 42. The second pin hole 42 has an inner surface 42a. The inner surface 42a has a shape of a surface of a conical frustum-shaped recess that corresponds to the outer surface 37a of the frustum-shaped portion 37 of the connecting pin 33. The shape of the surface of a conical frustum-shaped recess is a type of the surface of a conical or pyramidal recess.

<Nut Member>

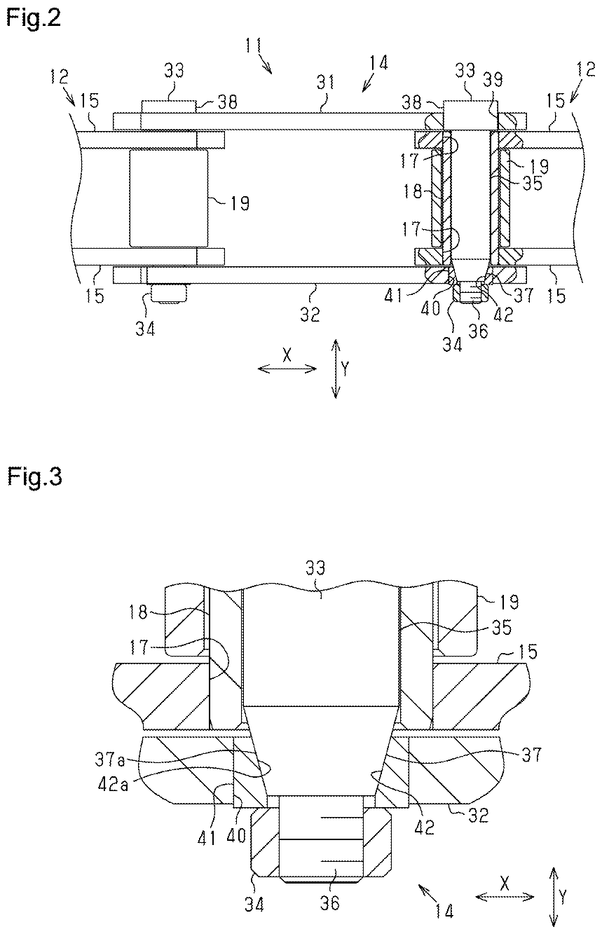

As shown in FIGS. 1 and 2, the nut member 34 is configured to be threaded to the external thread portion 36 at the distal end of the connecting pin 33. When the distal end of the connecting pin 33, which is integrated with the first link plate 31 in a cantilever-like manner, is inserted into the second pin hole 42 of the connecting bushing 41 of the second link plate 32, the external thread portion 36 of the connecting pin 33 protrudes from the second pin hole 42. The nut member 34 is threaded to the external thread portion 36 of the connecting pin 33, which protrudes from the second pin hole 42. Other than the type shown in FIGS. 1 and 2, in which a thread hole extends through the nut member 34, the nut member 34 may be of a cap nut, which has a closed end in the axial direction, so that the thread hole does not extend through the nut.

<Operation>

Operation of the present embodiment will now be described.

When the chain 11 is cut and connected using the connecting link 14, the connecting link 14 in a dissembled state is arranged in a space between two inner links 12 that are arranged adjacent to and separated from each other in the longitudinal direction X of the chain 11 as shown in FIG. 1. The distal ends of the two connecting pins 33, which extend from the first link plate 31 in a cantilever-like manner, are inserted into the bushings 18 of the inner links 12 at one side and the other side in the longitudinal direction X of the chain 11. The distal ends of the connecting pins 33, which are passed through the bushings 18, are inserted into the second pin holes 42 of the connecting bushings 41 in the second link plate 32.

When the distal end of the connecting pin 33 is inserted into the second pin holes 42 as shown in FIG. 3 in an enlarged manner, the external thread portion 36 is passed through the second pin hole 42, and the frustum-shaped portion 37 between the external thread portion 36 and the shaft portion 35 is fitted to the second pin hole 42 using recess-and-protrusion mating. The outer surface 37a of the frustum-shaped portion 37, which has a shape of the surface of a conical frustum, is in planar contact with the inner surface 42a of the second pin hole 42, which has a shape of the surface of a conical frustum-shaped recess. In this state, the nut member 34 is threaded to the external thread portion 36 of the connecting pin 33, which projects from the second pin holes 42, and the nut member 34 is tightened. The outer surface 37a of the frustum-shaped portion 37 of the connecting pin 33 is then frictionally engaged with the inner surface 42a of the second pin hole 42, so that the outer surface 37a and the inner surface 42a are in close contact with each other. That is, the frustum-shaped portion 37 of connecting pin 33 is fitted into the second pin hole 42 of the second link plate 32 in a closely contacting state, which corresponds to a state of interference fit.

At this time, if the nut member 34, which is threaded to the external thread portion 36 of the connecting pin 33, is tightened, the friction with the rotating nut member 34 may wear an end face of a section of the second link plate 32 that corresponds to the second pin hole 42, that is, an end face of the connecting bushing 41. However, such wear is restricted since the material of the connecting bushing 41 is harder than the material of the second link plate 32 and the like. Further, in the present embodiment, the second link plate 32 does not need to be made of a harder material than in a case in which the second pin hole 42 extends through the second link plate 32. This restricts the material costs from being increased.

A prolonged use of the chain 11 that has been cut and connected with the connecting link 14 may loosen the nut member 34. In such a case, the connecting pin 33 can rotate so that the inner surfaces of the first pin hole 39 and the second pin holes 42 are worn to increase the diameters of the holes 39, 42. The cut and connected chain 11 thus may be stretched undesirably. The present embodiment reduces the possibility of such undesirable stretching since the connecting pin 33 is restricted from rotating by the flat outer surfaces 38a of the proximal end 38 contacting the flat inner surfaces 39a of the first pin hole 39.

<Advantages>

The present embodiment has the following advantages.

(1) The frustum-shaped portion 37 of the connecting pin 33 is fitted into the second pin hole 42 of the second link plate 32 in a closely contacting state, which corresponds to a state of interference, without requiring significant time and effort. In this state, the proximal end 38 of the connecting pin 33 is press-fitted into the first pin hole 39 of the first link plate 31, and the outer surface 37a of the frustum-shaped portion 37 at the distal end does not slide against the inner surface 42a of the second pin holes 42 of the second link plate 32. Thus, even after a prolonged use, the cut and connected chain 11 is restricted from being stretched undesirably due to increase in the diameters of the first pin hole 39 and the second pin holes 42 caused by wear.

(2) The connecting bushing 41 has a high hardness. Thus, when the nut member 34, which is threaded to the external thread portion 36 of the connecting pin 33, is tightened, the friction with the rotating nut member 34 is unlikely to wear a section of the second link plate 32 that corresponds to the second pin hole 42, that is, the connecting bushing 41.

(3) The connecting bushing 41 is a component formed separately from the second link plate 32 and includes the second pin hole 42, which closely contacts the frustum-shaped portion 37 of the connecting pin 33. This allows solely the connecting bushing 41 to be made of a special material that, for example, achieves close contact with the frustum-shaped portion 37. It is thus unnecessary to form the entire second link plate 32 with a special material that achieves a close contact with the frustum-shaped portion 37. This expands the range of choice of the material for the second link plate 32.

(4) The nut member 34 may be loosened on the external thread portion 36 of the connecting pin 33. In such a case, the flat inner surface 39a, which functions as a rotation restricting portion in the first pin hole 39, restricts the connecting pin 33 from unintentionally rotating relative to the first pin hole 39 and the second pin hole 42.

The above-described embodiment may be modified as follows. The features included in the above-described embodiment and the features included in the following modifications can be combined. Also, the features included in the following modifications can be combined.

A connecting link 14 according to a first modification shown in FIG. 5 may be used. The connecting link 14 includes a block-shaped protrusion 51 located close to the open edge of each first pin hole 39 of the first link plate 31. The protrusion 51 is, for example, a vertically elongated rectangular parallelepiped, and has a flat side surface 51a on a side facing the first pin hole 39. In this case, the first pin hole 39 of the first link plate 31 has the same diameter as the columnar shaft portion 35 of the connecting pin 33 or has approximately the same diameter as the shaft portion 35 with tolerances.

The proximal end 38 of the connecting pin 33 is shaped as a flange of which the diameter is larger than that of the first pin hole 39. The proximal end 38 includes a cutout flat portion 38c in a part in the outer circumference. That is, when the connecting pin 33 is press-fitted into the first pin hole 39, an outer circumferential surface 35a of the shaft portion 35 is frictionally engaged with an inner circumferential surface 39c of the first pin hole 39. Also, the cutout flat portion 38c of the proximal end 38 contacts the flat side surface 51a of the block-shaped protrusion 51 to restrict rotation. That is, in the first modification, the rotating restricting portion is formed by the flat side surface 51a of the block-shaped protrusion 51, which is close to the open edge of the first pin hole 39 of the first link plate 31. The rotation restricting portion in this case is not limited to the flat side surface 51a of the block-shaped protrusion 51 as long as it contacts the cutout flat portion 38c of the proximal end 38 of the connecting pin 33 to restrict rotation of the connecting pin 33. For example, the rotation restricting portion may be a structure that includes at least one protrusion that contacts another structure.

The connecting link 14 according to the first modification shown in FIG. 5 does not necessarily need to be configured such that the proximal end 38 of the connecting pin 33 is shaped as a flange of which the diameter is larger than that of the first pin hole 39, but may be configured such that a cutout flat portion 38c is formed in one or more sections in the outer circumference having the same diameter as the shaft portion 35. In this case, at the opening edge of the first pin hole 39 of the first link plate 31, the protrusion 51, which contacts the cutout flat portion 38c of the proximal end 38 of the connecting pin 33, is formed to correspond to the cutout shape of the cutout flat portion 38c, so as to partly cover the first pin hole 39. The proximal end 38 of the connecting pin 33 is press-fitted into the first pin hole 39 so as to pass through the first pin hole 39 from the inside in the width direction Y, which is on the left side as viewed in FIG. 5, so that the cutout flat portion 38c is located on the outside, or the right side as viewed in FIG. 5. The cutout flat portion 38c contacts the protrusion 51, and the portion that has the same diameter as the shaft portion 35 is non-rotatable.

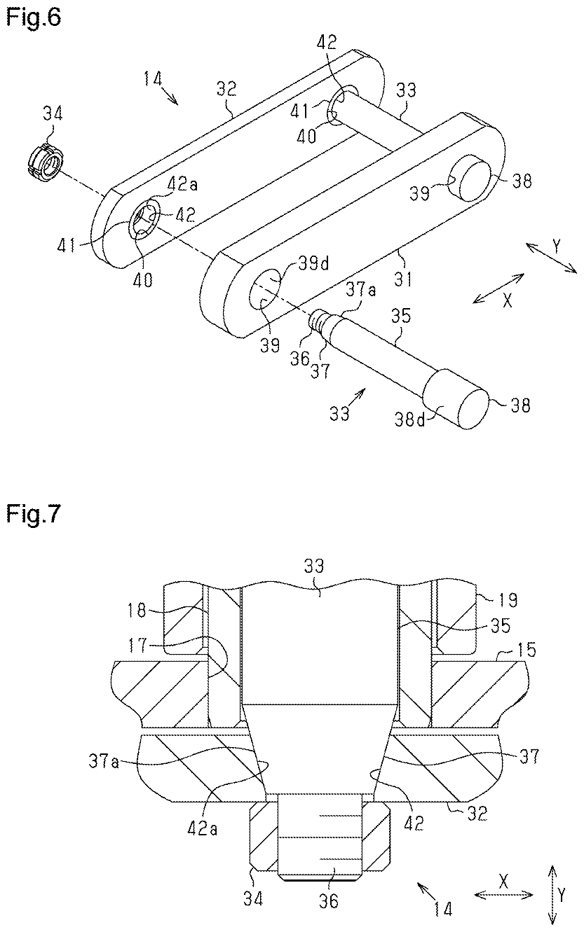

A connecting link 14 according to a second modification shown in FIG. 6 may be used. This connecting link 14 is configured such that the proximal end 38 of the connecting pin 33 is columnar and has a diameter larger than that of the shaft portion 35. The thickness of the first link plate 31 is greater than that of the above-described embodiment or the first modification, and the first pin hole 39 has the same diameter as that of the proximal end 38 of the connecting pin 33, which has a large diameter. The length of the proximal end 38 of the connecting pin 33 is greater than the thickness of the first link plate 31. The second modification restricts the connecting pin 33 from rotating by frictional engagement in a relatively large contacting area between an outer circumferential surface 38d of the proximal end 38 of the connecting pin 33 and an inner circumferential surface 39d of the first pin hole 39, which is larger than that in the above-described embodiment or the first modification. That is, the rotation restricting portion of the second modification is formed by the inner circumferential surface 39d of the first pin hole 39, which has a relatively large contact area with the outer circumferential surface 38d of the proximal end 38 of the connecting pin 33. Further, the proximal end 38 of the connecting pin 33 may be columnar and have a diameter smaller than or equal to that of the shaft portion 35. In this case, the first pin hole 39 has the same diameter as the proximal end 38 of the connecting pin 33.

A connecting link 14 according to a third modification shown in FIG. 7 may be used. The second pin hole 42 of this connecting link 14 is formed directly in the second link plate 32. In this case, the material of the entire second link plate 32 or the material of a portion of the second link plate 32 in which the second pin holes 42 is formed is preferably a high-hardness material such as a stainless steel. That is, a portion of the second link plate 32 in which the second pin hole 42 may be made of any material that is harder than that of portions in which the second pin hole 42 is not formed.

In the connecting link 14 of the above-described embodiment shown in FIG. 4, the opening of the first pin hole 39 of the first link plate 31 may have a D-shape or a rectangular shape with one or more than two flat inner surfaces 39a on the inner surface. Also, the first pin hole 39 of the first link plate 31 according to the above-described embodiment may have an opening shape in which the flat inner surfaces 39a extend in the traverse direction of the first link plate 31. Further, the first pin hole 39 of the first link plate 31 of the above-described embodiment may be configured such that the longest distance between the concave inner surfaces 39b, which face each other, is equal to the outer diameter of the shaft portion 35 of the connecting pin 33, and that the distance between the flat inner surfaces 39a, which face each other, is smaller than the outer diameter of the shaft portion 35 of the connecting pin 33. In these cases, the cross-sectional shape of the proximal end 38 of the connecting pin 33 preferably agrees with the opening shape of the first pin hole 39.

The clearance between the first pin hole 39 of the first link plate 31 and the shaft portion 35 or the proximal end 38 of the connecting pin 33, which is press-fitted into the first pin hole 39, may be filled with an adhesive, so that the bonding force of the adhesive functions as a rotation restricting portion.

The connecting bushing 41 and the second link plate 32 may be made of the same material. In this case, however, the material of the connecting bushing 41 is preferably harder than that of the nut member 34.

The connecting links 14 of the above-described embodiment, the first modification, and the second modification, may be configured such that the connecting bushing 41 and the second link plate 32 differ from each other only in the surface property. Likewise, the connecting link 14 of the third modification may be configured such that sections of the second link plate 32 in which the second pin holes 42 are formed and sections other than the sections in which the second pin holes 42 are formed differ from each other only in the surface property. That is, only the surfaces may differ from each other in a property such as the hardness or the degree of close contact. In this case, components having the same surface property may be prepared, and then different treatments such as different thermal treatments may be performed on the surfaces of the components, so that a surface property such as the hardness differ between the components.

The connecting links 14 of the above-described embodiment, the first modification, and the second modification, may be configured such that the hardness of at least the surface of the connecting bushing 41 is lower than the hardness of at least the surface of the second link plate 32. Likewise, the connecting link 14 of the third modification may be configured such that the hardness of at least the surface of the sections in the second link plate 32 in which the second pin holes 42 are formed is lower than the hardness of at least the surface of the sections other than the sections in which the second pin holes 42 are formed.

The shape of the frustum-shaped portion 37 of the connecting pin 33 is not limited to a conical frustum, but may be a polygonal frustum such as a triangular frustum or a quadrangular frustum. In this case, the second pin hole 42 preferably has a shape of the surface of a polygonal frustum recess, so that the inner surface 42a is fitted to the outer surface 37a of the frustum-shaped portion 37, which has a shape of a polygonal frustum, using recess-and-protrusion mating.

The chain 11 of the above-described embodiment is of a flat type. That is, the chain 11 includes the inner links 12 and the outer links 13, which alternate in the longitudinal direction X, and the distance in the width direction Y between the inner link plates 15 of the inner link 12 and the distance in the width direction Y between the outer link plates 16 in the outer link 13 are respectively constant at one side and the other side in the longitudinal direction X. However, the chain 11 may be of an offset type, which includes links that are coupled together in series in a longitudinal direction X, and in which the distance between link plates that face each other in the width direction Y at one side is different from the distance at the other side in the longitudinal direction X. In this case, each of the first link plate 31 and the second link plate 32 of the connecting link 14 preferably includes a bent portion in a middle section in the longitudinal direction. The bent portion is bent toward the other link plate, which faces the middle section in the width direction Y. Also, in a case in which the distance in the width direction Y between the first link plate 31 and the second link plate 32 is shorter at one end than at the other end in the longitudinal direction, the holes formed in the sections of the shorter distance preferably receive the shaft portion 35 of the connecting pin 33 in a rotatable manner. These holes are preferably neither the first pin hole 39 nor the second pin holes 42, but are circular holes having a diameter slightly larger than the diameter of the shaft portion 35 of the connecting pin 33.

The connecting pin 33 of the connecting link 14 may be restricted from coming out of the first pin hole 39 by crimping the proximal end 38, which protrudes outward from the first pin hole 39 of the first link plate 31, after cutting and connecting the chain 11.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A connecting link used to connect a cut chain, the chain including links arranged in series in a longitudinal direction of the chain, and the links adjacent to each other in the longitudinal direction being pivotally coupled to each other, the connecting link comprising:
a connecting pin including an external thread portion at a distal end and a frustum-shaped portion between the external thread portion and a proximal end, the frustum-shaped portion being formed to have a cross-sectional area increasing toward the proximal end;
a first link plate including a hole capable of receiving the connecting pin at each of one end and an other end in a longitudinal direction, at least one of the hole at the one end and the hole at the other end functioning as a first pin hole into which a proximal end of the connecting pin is fitted so as to be non-rotatable;
a second link plate including a hole capable of receiving the connecting pin at each of one end and an other end in a longitudinal direction, at least one of the hole at the one end and the hole at the other end functioning as a second pin hole, the external thread portion of the connecting pin being passable through the second pin hole, the second pin hole including an inner surface, the inner surface having a shape of a conical or pyramidal recess that corresponds to an outer surface of the frustum-shaped portion; and
a nut member capable of being threaded to the external thread portion of the connecting pin.

2. The connecting link according to claim 1, wherein a section of the second link plate in which the second pin hole is formed and a section other the section in which the second pin hole is formed differ from each other at least in a surface property.

3. The connecting link according to claim 1, wherein the second link plate includes a fitting hole, a connecting bushing that includes the second pin hole being fitted into the fitting hole so as to be non-rotatable.

4. The connecting link according to claim 1, wherein the first link plate includes a rotation restricting portion that restricts the connecting pin from rotating relative to the first pin hole.

5. A chain, comprising:
links arranged in series in a longitudinal direction of the chain;
a coupling pin that pivotally couples the links adjacent to each other in the longitudinal direction to each other; and
the connecting link according to claim 1, wherein the connecting link is located in an intermediate portion in the longitudinal direction of the chain, and
the connecting link couples the link adjacent to the connecting link on one side in the longitudinal direction to the link adjacent to the connecting link on an other side.
